(19) United States
(12) Patent Application Publication
(10) Pub. No.: US 2002/0183122 A1
(43) Pub. Date: Dec. 5, 2002

(54) Constant velocity universal joint

(76) Inventors: Keisuke Sone, Shizuoka-ken (JP); Kazuhiko Hozumi, Shizuoka-ken (JP); Haruo Nagatani, Shizuoka-ken (JP); Tatsuro Sugiyama, Shizuoka-ken (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/139,642

(22) Filed: May 7, 2002

(30) Foreign Application Priority Data
May 31, 2001 (JP) 2001-164854

(51) Int. Cl. F16D 3/16

(52) U.S. Cl. 464/112

(57) ABSTRACT

A constant velocity universal joint is provided, which can ensure a smooth torque transmission, extend the useful life thereof, maintain the constant velocity, and damp vibrations and abnormal sounds. The constant velocity universal joint having at least two sets of link mechanisms. The link mechanism has: link hubs installed in an input shaft and an output shaft, respectively; end link members rotatably each coupled with the link hubs installed in the respective input and the output shafts; and a central link member to which the end link members on the respective input and output shaft sides are rotatably coupled. Geometries of the mechanism on the input shaft side and the output shaft side are identical to each other across a transverse plane in a center of the link mechanism. The universal joint further has rotational resistance reducing means installed in at least either coupling part between the link hub and the end link member or coupling part between the central link member and the end link member. As the rotational resistance reducing means, a ball bearing is installed in the coupling part.

### BACKGROUND OF THE INVENTION

1. Field of the Invention

This invention relates to a constant velocity universal joint that is installed in the steering system of an automobile for torque transmission between two shafts.

2. Description of the Related Art

One of the examples of constant velocity universal joints that are installed in the steering system of an automobile for torque transmission between two shafts is a link-type constant velocity universal joint disclosed in Japanese Patent Publication No. Sho. 47-51502.

Referring now to FIGS. 14(a) and 14(b), this link-type constant velocity universal joint has at least two link mechanism 3 sets that link an input shaft 1 and an output shaft 2 (only one link mechanism 3 set is shown in the drawings). The link mechanism 3 has two link hubs 10 that are each installed in the input shaft 1 and the output shaft 2 and shared with the other link mechanisms 3, two end link members 20 each rotatably coupled with the individual link hubs 10, and one central link member 30 that is rotatably coupled with the end link members 20 so as to interconnect these end link members 20 to each other. The link hub 10 and the end link member 20 on the input side make a large operation angle with the link hub 10 and the end link member 20 on the output side. Thus they are located to take positions rotationally symmetric across center line A in the central link member 30.

Referring now to FIGS. 15(a) and 15(b), the link hub 10 has a plurality of leg shafts 11 (three in the drawings) thereon that project in the radial direction. The angle, α, between a leg shaft 11 and either input shaft 1 or output shaft 2 is set at 90 degrees, considering the positional relationship of the link mechanism 3 that is configured to define a rotationally symmetric structure. The leg shafts 11 do not need to be spaced evenly in the circumferential direction. On the other hand, the hub links 10 on the input and output sides need to occupy conforming positions in the circumferential direction.

As shown in FIGS. 16(a) and 16(b), the end link member 20 which is formed into an L-shape has a coupling bore 21 that rotatably receives the leg shaft 11 of the link hub 10 on one side and a coupling bore 22 that rotatably receives a leg shaft 32 of the central link member 30 on the other side. The angle, β, between the coupling bore 21 on the hub link side and the coupling bore 22 on the central link member side is set at 90 degrees, considering the positional relationship of the link mechanism 3 that is configured to define a rotationally symmetric structure.

As shown in FIGS. 17(a) and 17(b), the central link member 30 has an L-shape base member 31 and leg shafts 32 each coupled with the respective coupling holes 22 of the end link members 20 on the input shaft side and output shaft side, on both sides of its L-shaped base 31. The angle, φ, between the leg shafts 32 on the input and output shaft sides is set at the 40-100 degrees range for practical use. If this angle is smaller than 40 degrees, the outer diameter of the central link member 30 becomes too big, while if larger than 100 degrees the central link member 30 becomes too long in the axial direction and the operation angle becomes small due to mechanical interference.

In the link mechanism 3, when the leg shaft angle α and length of the link hub 10 and the geometry of the end link member 20 on the input shaft side are the same as those on the output shaft side and when the geometry of the central link member 30 on the input shaft side is the same as that on the output shaft side, the link hub 10 and the end link member 20 on the input side and those on the output side move in synchronization with each other and then the input shaft 1 and the output shaft 2 make the same rotational angle and rotate at the same angular speed (see FIGS. 18(a) and 18(b)), provided that the angular relation on the input shaft side between the central link member 30 and the end link member 20 coupled with the leg shaft 11 of the link hub 10 is controlled to be the same, with respect to the symmetry plane in the central link member 30, as that on the output shaft side. If the input shaft and the output shaft rotate at the same angular speed, the symmetry plane in the central link member 30 is referred to as the constant-velocity bisecting plane.

If a plurality of link mechanisms 3 that have the same geometry and share link hubs 10 on the input and output shaft sides are installed in the circumferential direction, the range of movements with no interference between those link mechanisms 3 is limited to the constant-velocity bisecting plane in the central link member 30, and the input shaft 1 and the output shaft 2 rotate at the same angular speed whatever operation angle γ they make.

This link-type constant velocity universal joint, however, cannot transmit torque smoothly because of a large rotation resistance and its life of use is short because of a large frictional resistance experienced during rotation. This is because the coupling part between the leg shaft 11 of the link hub 10 and the end link member 20 as well as the coupling part between the leg shaft 32 of the central link member 30 and the end link member 20 experience large frictional resistance. Besides, the large gaps in those coupling parts cause significant backlash between the input shaft 1 and the output shaft 2, leading to irregular movements during operation. As a result, it becomes difficult to maintain a constant velocity and vibrations and abnormal sounds are produced.

### SUMMARY OF THE INVENTION

An object of this invention is to ensure smooth torque transmission, improve the useful life, maintain a constant velocity by preventing backlash in the input and output shafts, and damp vibrations and abnormal sounds of the universal joint.

For attaining the above object, the present invention provides a constant velocity universal joint having at least two sets of link mechanisms, the link mechanism having: link hubs installed in an input shaft and an output shaft and shared with other link mechanisms, respectively; end link members rotatably each coupled with the link hubs installed in the respective input and the output shafts; and a central link member to which the end link members on the respective input and output shaft sides are rotatably coupled, geometries of the mechanism on the input shaft side and the output shaft side being identical to each other across a transverse plane in a center of the link mechanism, wherein the joint further has rotational resistance reducing means installed in at least either coupling part between the link hub and the end link member or coupling part between the central link member and the end link member. Herein, the description “geometries of the mechanism on the input shaft side and the output shaft side being identical to each other across a transverse plane in a center of the link mechanism” means that if the constant velocity universal joint is divided across the symmetric plane in the central link member into two parts on the input shaft side and the output shaft side, the geometries on the input shaft side and the output shaft side are identical to each other.

In the present invention, the rotational resistance reducing means is installed in at least either coupling part between the link hub and the end link member or coupling part between the central link member and the end link member. Then since the frictional resistance in coupling parts is reduced and the rotational resistance is thereby lowered, a smooth torque transmission can be provided and the useful life can be extended.

Such rotational resistance reducing means may be a structure where a roller bearing is installed in the coupling part. This means may also be a structure where a journal bearing such as a roller bearing and a thrust bearing such as a slide bearing are installed in combination in the coupling part. It is preferable to install a preload-providing means that applies a preload to the bearing. A preload helps reduce irregular movements in the coupling parts, prevent backlash between the input and output shaft sides, maintain a constant velocity and damp vibrations and abnormal sounds.

### BRIEF DESCRIPTION OF THE DRAWINGS

In the accompanying drawings:

FIG. 1(a) is a front view of a constant velocity universal joint according to the present invention, and FIG. 1(b) is a plan view of the universal joint shown in FIG. 1(a);

FIG. 2 is an enlarged sectional view of the major part showing a first embodiment of the invention;

FIG. 3 is an enlarged sectional view of the major part showing a second embodiment of the invention;

FIG. 4 is an enlarged sectional view of the major part showing a third embodiment of the invention;

FIG. 5 is an enlarged sectional view of the major part showing a fourth embodiment of the invention;

FIG. 6 is an enlarged sectional view of the major part showing a fifth embodiment of the invention;

FIG. 7 is an enlarged sectional view of the major part showing a sixth embodiment of the invention;

FIG. 8 is an enlarged sectional view of the major part showing a seventh embodiment of the invention;

FIG. 9 is an enlarged sectional view of the major part showing an eighth embodiment of the invention;

FIG. 10 is an enlarged sectional view of the major part showing a ninth embodiment of the invention;

FIG. 11 is an enlarged sectional view of the major part showing a tenth embodiment of the invention;

FIG. 12 is an enlarged sectional view of the major part showing an eleventh embodiment of the invention;

FIG. 13(a) is a plan view showing a twelfth embodiment of the invention, and FIG. 13(b) is a front view of universal joint shown in FIG. 13(a);

FIG. 14(a) is a front view of a link-type constant velocity university joint, and FIG. 14(b) is a plan view of the universal joint shown in FIG. 14(a);

FIG. 15(a) is a front view of a link hub, and FIG. 15(b) is a side view of the link hub shown in FIG. 15(a);

FIG. 16(a) is a front view of an end link member, and FIG. 16(b) is a side view of the end link member shown in FIG. 16(a);

FIG. 17(a) is a front view of a central link member, and FIG. 17(b) is a side view of the central link member shown in FIG. 17(a); and

FIG. 18(a) is a front view of the link-type constant velocity universal joint of FIG. 14(a) that is in the state of taking an operation angle, and FIG. 18(b) is a rear view of the universal joint shown in FIG. 18(a).

### DETAILED DESCRIPTION OF THE PREFERRED EMBODIMENTS

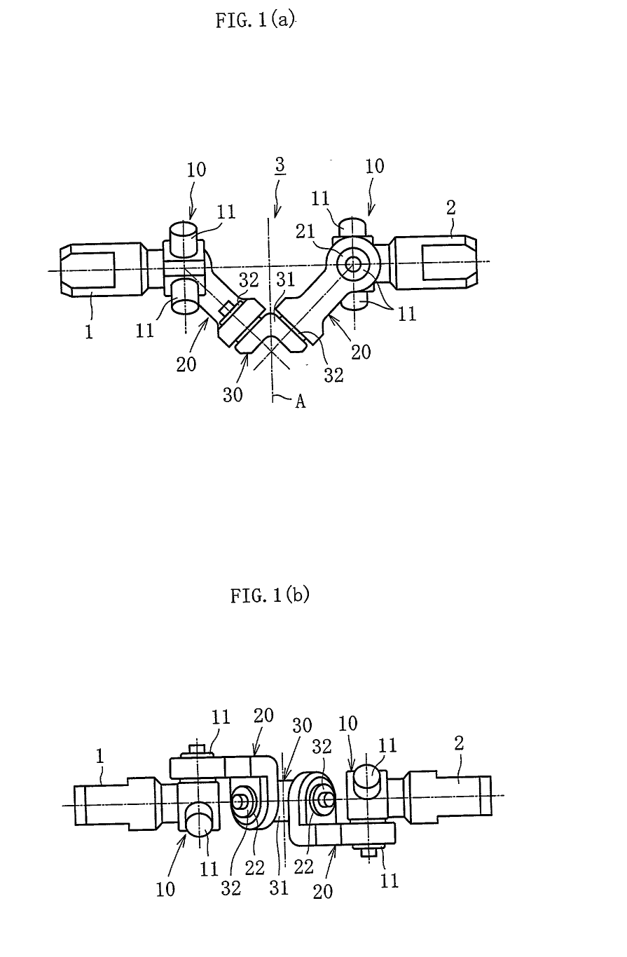

FIGS. 1(a) and 1(b) illustrate an embodiment of a link-type constant velocity universal joint in accordance with the present invention. This constant velocity universal joint has at least two link mechanism 3 sets to couple an input shaft 1 with an output shaft 2 (in the figure, only one link mechanism 3 set is shown). A link mechanism 3 has link hubs 10 each installed in the input shaft 1 and output shaft 2 respectively, two end link members 20 each rotatably coupled with the individual link hubs 10, and a central link member 30 that is rotatably coupled with the end link members 20 to interconnect these end link members 20 to each other. The link hub 10 has a plurality of leg shafts 11 that radially project (three in the drawings). The end link member 20 which is formed into an L-shape has a coupling bore 21 that rotatably receives the leg shaft 11 of the link hub 10 on one side and a coupling bore 22 that rotatably receives a leg shaft 32 of the central link member 30 on the other side. The central link member 30 has an L-shaped base member 31 and leg shafts 32 on both sides of the L-shaped base member 31. The leg shafts 32 are each coupled with the respective coupling bores 22 of the end link members 20 on the input shaft and output shaft sides. This link mechanism 3 is configured such that its geometry is symmetric on the input and output shaft sides across the transverse plane in the center. Because of this geometric symmetry, the link hub 10 and the end link member 20 on the input shaft side synchronize in rotation with the link hub 10 and the end link member 20 on the output shaft side. Then the input shaft 1 and the output shaft 2 make the same rotational angle and they rotate at the same angular speed whatever operation angle they take.

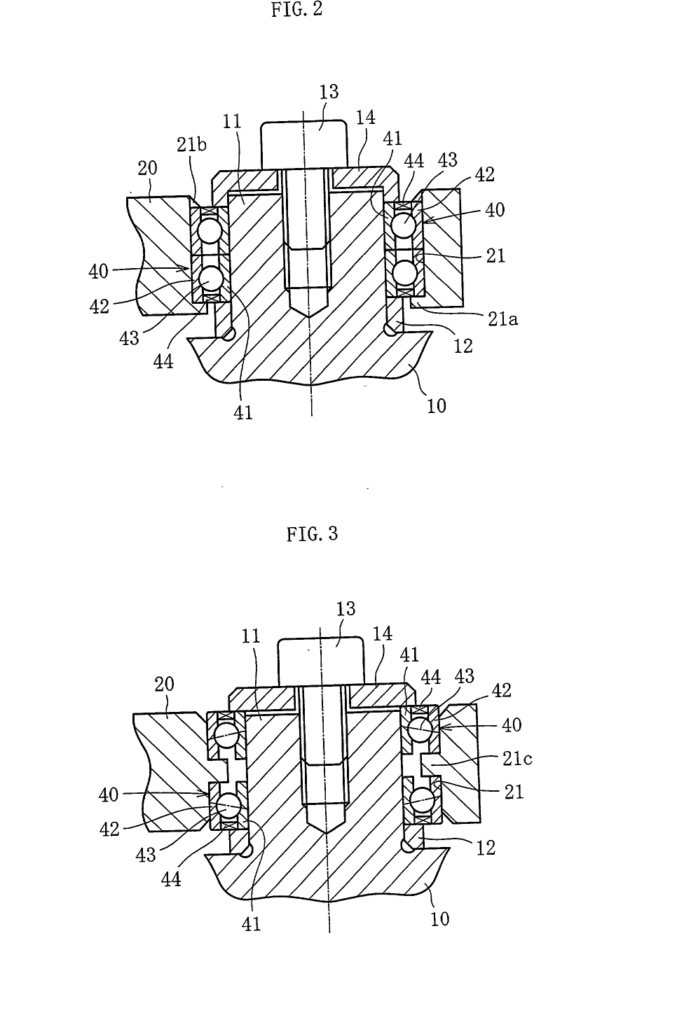

In a first embodiment shown in FIG. 2, the leg shaft 11 of the link hub 10 is inserted into the coupling bore 21 of the end link member 20, and the leg shaft 11 of the link hub 10 is rotatably coupled with the end link member 20 via two ball bearings 40 installed between the leg shaft 11 and the coupling bore 21. The ball bearing 40 has an inner ring 41 fitted on the outer peripheral surface of the leg shaft 11 of the link hub 10, an outer ring 42 fitted in the coupling bore 21 of the end link member 20 and a plurality of rollers (for example, balls) 43 installed between the inner ring 41 and the outer ring 42.

A washer 12 mounted on the base portion of the leg shaft 11 and a cap 14 secured on the leg shaft 11 with a bolt 13 retain the inner ring 41 to prevent its slipping off. An inward collar 21a formed in the coupling bore 21 of the end link member 20 and a fastener 21b formed by plastic deformation in the coupling bore 21 of the end link member 20 prevent the outer ring 42 from slipping off. The plurality of rollers 43 are rotatably retained at controlled intervals by a cage (not shown). The ball bearing 40 has a seal member 44 only on the side exposed to the outside to prevent the leakage of grease filled in the bearing and intrusion of water and foreign matters from the outside.

Since two bearings 40 are installed in the first embodiment of the invention, the frictional resistance in the coupling part between the end link member 20 and the link hub 10 is lowered and the rotational resistance is reduced. As a result, a smooth torque transmission is ensured and the useful life is extended.

In a second embodiment shown in FIG. 3, a preload is applied to two ball bearings 40 in the coupling structure for the end link member 20 and the link hub 10 in the first embodiment. Namely, the two ball bearings 40 are installed in parallel on the leg shaft 11 of the link hub 10 at a predetermined interval, and an inward collar 21c formed in the center of the coupling bore 21 of the end link member 20 is engaged between the outer rings 42 of the ball bearings 40. When the bolt 13 is tightened to push the cap 14 in the axial direction of the leg shaft 11 and to press the inner ring 41 of the ball bearing 40 positioned upper in the figure, a preload is applied to the pair of bearings 40 in order to eliminate radial gaps and thrust gaps.

According to the second embodiment, since the bolt 13 applies a preload to the two ball bearings 40 to eliminate radial gaps and thrust gaps, the backlash in the coupling part between the end link member 20 and the link hub 10 is prevented. Then the input shaft 1 and the output shaft 2 are synchronized in their rotary movements. As a result, a constant velocity is maintained, and vibrations and abnormal sounds are damped.

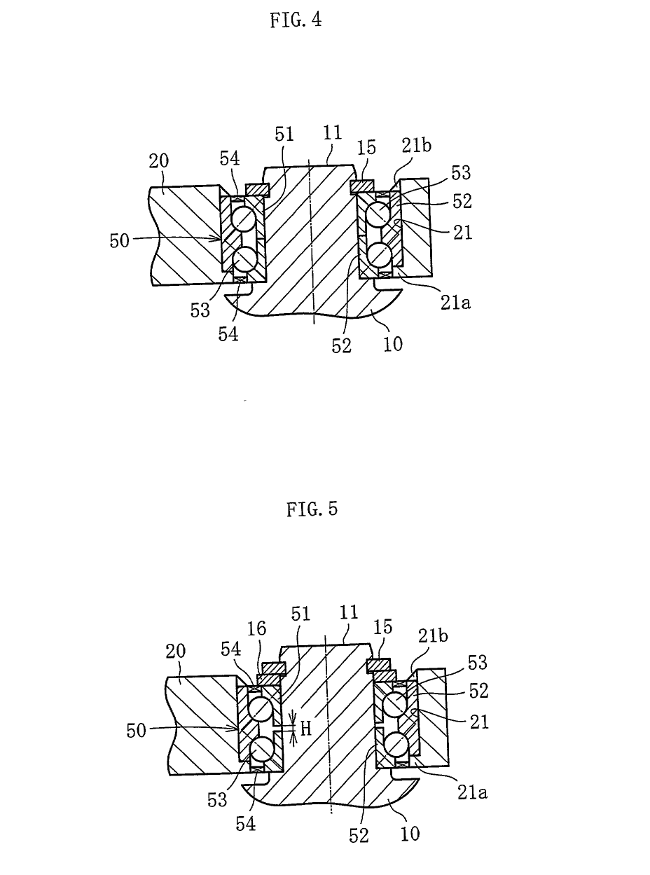

As shown in a third embodiment of FIG. 4, a double row angular ball baring 50 may be installed between the leg shaft 11 and the coupling bore 21. The double row angular ball baring 50 has two inner rings 51 fitted in parallel on the outer peripheral surface of the leg shaft 11, an outer ring 52 fitted in the coupling bore 21 of the end link member 20 and a plurality of rollers (balls) 53 installed in two rows between the inner ring 51 and the outer ring 52.

A snap ring 15 fitted on the leg shaft 11 secures the inner ring 51 to prevent its slipping off. An inward collar 21a formed in the coupling bore 21 of the end link member 20 and a fastener 21b formed by plastic deformation in the coupling bore 21 of the end link member 20 prevent the outer ring 52 from slipping off. The plurality of rollers 53 installed in two rows are rotatably held at controlled intervals by a cage (not shown). As is the case with the first embodiment, the double row angular ball bearing 50 has seal members 54 at both ends.

Since the double row angular ball bearing 50 is installed in the third embodiment of the invention, the rotational resistance is reduced as is the case with the first embodiment. As a result, a smooth torque transmission is ensured and the useful life is extended. Furthermore, since the double row angular ball bearing 50 is fastened with the snap ring 15, the retention structure for the bearings can be simplified, compared with the first embodiment shown in FIG. 2.

In a fourth embodiment shown in FIG. 5, a preload is applied to the double row angular ball bearing 50 in the coupling structure of the third embodiment shown in FIG. 4. Namely, the inner rings 51 of the double row angular ball bearing 50 are spaced at a predetermined gap H and for the control of this gap a shim 16 is inserted between the snap ring 15 and the inner ring 51 positioned upper in the figure of the double row angular ball bearing 50. By controlling the gap H between the inner rings 51 with the shim 16, a preload is given to the double row angular ball bearing 50 via the shim 16 to eliminate radial gaps and axial gaps.

Since the radial and thrust gaps are eliminated by applying a preload to the double row angular ball bearing 50 via the shim 16 in the fourth embodiment, the backlash in the coupling part is prevented as is the case with the second embodiment. Then a constant velocity is maintained, and vibrations and abnormal sounds are reduced. Moreover, since a preload is applied to the double row angular ball bearing 50 via the shim 16 in the fourth embodiment, the bolt 13 used in the second embodiment shown in FIG. 3 becomes unnecessary and the height of the leg shaft 11 can be reduced.

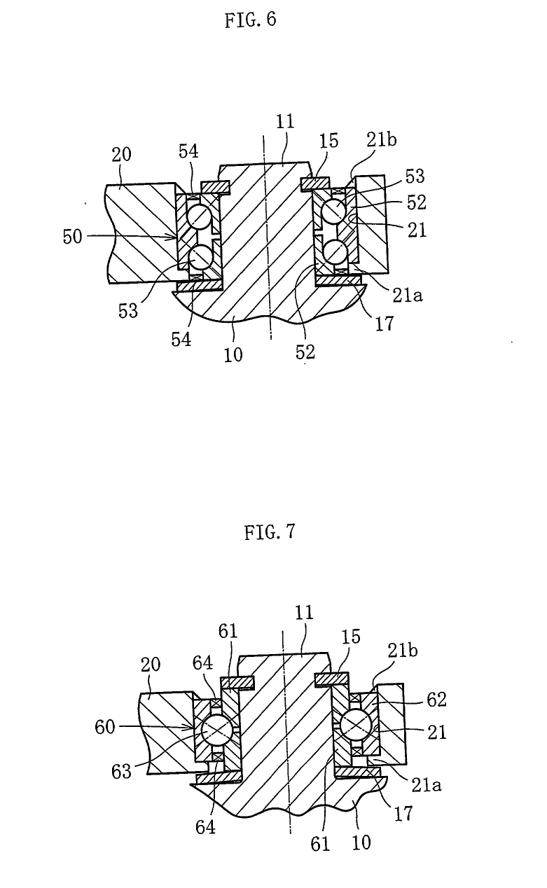

In a fifth embodiment shown in FIG. 6, a plate spring 17 gives a preload to the double row angular ball bearing 50 in the coupling structure of the fourth embodiment shown in FIG. 5. Namely, a resilient plate spring 17 is inserted between the base portion of the leg shaft 11 and the inner ring 51 of the double row angular ball bearing 50 positioned lower in the figure. The resilient force of the plate spring 17 pushes the inner ring 51 to provide a preload for the double row angular ball bearing 50 via the inner ring 51, and thereby the radial and thrust gaps are eliminated.

In addition to the maintenance of constant velocity and prevention of vibrations and abnormal sounds attained by the fourth embodiment, the fifth embodiment can eliminate the need of the gap control mechanism using the shim 16 employed in the fourth embodiment and reduce backlash even if there is some wear in the coupling structure.

A sixth embodiment shown in FIG. 7 has a structure in which a four-point contact ball bearing 60 is installed between the leg shaft 11 and the coupling bore 21. The four-point contact ball bearing 60 has two inner rings 61 fitted on the outer peripheral surface of the leg shaft 11 of the link hub 10, an outer ring 62 fitted in the coupling bore 21 of the end link member 20 and a plurality of rollers (balls) 63 installed between the inner rings 61 and the outer ring 62.

A snap ring 15 prevents the inner rings 61 from slipping off, while a collar 21a formed in the end link member 20 and a fastener 21b prevent the outer ring 62 from slipping off. The rollers 63 are rotatably held at controlled intervals by a cage (not shown), providing four contact points between each of the inner rings 61 and the outer ring 62. The four-point contact ball bearing 60 has seal members 64 at its both ends.

A resilient plate spring 17 is installed between the base portion of the leg shaft 11 and the inner ring 61 positioned lower in the figure illustrating the four-point contact ball bearing 60. When the resilient force of the plate spring 17 pushes the inner ring 61, a preload is applied to the four-point contact ball bearing 60 to eliminate radial and thrust gaps.

Since the four-point contact ball bearing 60 is installed and the preload applied by the plate spring 17 to the four-point contact ball bearing 60 eliminates radial and thrust gaps in the sixth embodiment, the friction in the coupling part is reduced. Then a smooth torque transmission is ensured and the useful life is extended. At the same time, the backlash in the coupling part is prevented, a constant velocity is maintained, and vibrations and abnormal sounds are damped.

These embodiments that have been described have the ball bearing 40, double row angular ball bearing 50 or four-point contact ball bearing 60 in the coupling part between the end link member 20 and the link hub 10. However, the present invention is not limited thereto, and other roller bearings may be used.

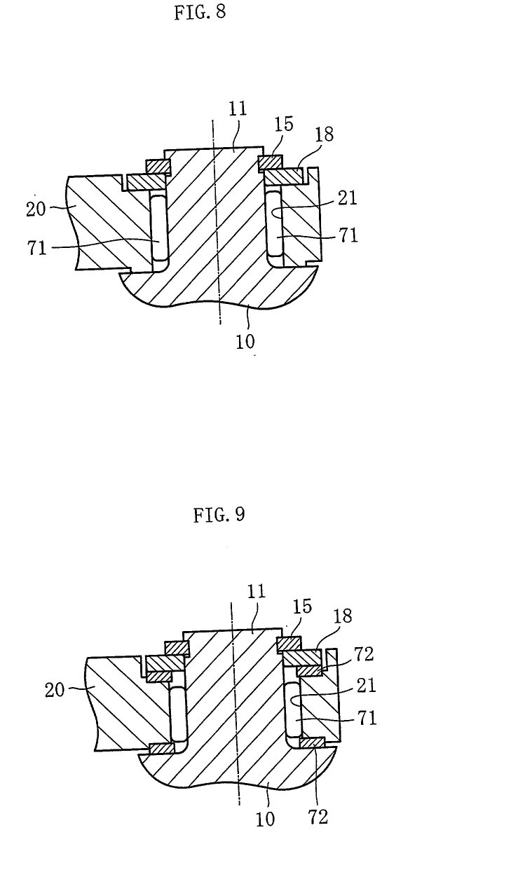

A seventh embodiment shown in FIG. 8 has a plurality of needle bearings 71 between the leg shaft 11 and the coupling bore 21. Slipping off of the end link member 20 is prevented by a washer 18 retained by a snap ring 15. The needle bearings 71 are rotatably held as they roll with no cage.

Since the plurality of needle bearings 71 are installed in the seventh embodiment, a smooth torque transmission is ensured and the useful life is extended. At the same time, the load tolerance can be raised without enlarging the diameter of the coupling bore 21 of the end link member 20.

In an eighth embodiment shown in FIG. 9, sliding members (sliding bearings) 72 are inserted between the end link member 20 and the base portion of the leg shaft 11 and between the end link member 20 and the washer 18 in the coupling structure of the seventh embodiment. A plurality of needle bearings 71 receive the load in the radial direction, while the sliding members 72 receive the load in the thrust direction. The sliding member 72 is made of resin materials having low friction coefficients such as, for example, fluororesin, polyimide, polyethylene, polyamideimide.

In the eighth embodiment, the sliding member 72 further lowers the frictional resistance in the coupling part between the end link member 20 and the link hub 10. Besides, the backlash in the axial direction is also prevented by the sliding member 72.

In a ninth embodiment shown in FIG. 10, a shell-type needle bearing 80 is inserted between the leg shaft 11 and the coupling bore 21. The shell-type needle bearing 80 has a cup-shape shell outer ring 81 fitted in the coupling bore 21 of the end link member 20 and a plurality of needle bearings 82 inserted between the inner surface of the outer ring 81 and the outer peripheral surface of the leg shaft 11 of the link hub 10.

Slipping off of the outer ring 81 is prevented by a fastener 21b formed by plastic deformation in the coupling bore 21 of the end link member 20. The displacement of the end link member 20 in the axial direction is restricted by an inward collar 21a formed in the coupling bore 21 and the snap ring 19 secured to the leg shaft 11. A seal member 83 is inserted between the inner peripheral surface of the collar 21a of the end link member 20 and the base portion of the leg shaft 11. A sliding member (sliding bearing) 84 is inserted between the collar 21a of the end link member 20 and the snap ring 19 to receive the load with the sliding member 84 in the thrust direction. The sliding member 84 is made of resin materials having low friction coefficients such as, for example, fluororesin, polyimide, polyethylene, polyamideimide.

Since the shell-type needle bearing 80 is installed between the end link member 20 and the leg shaft 11 and the displacement of the end link member 20 in the axial direction with respect to the leg shaft 11 are restricted with the snap ring 19 in the ninth embodiment, the frictional resistance in the coupling part is reduced. Then a smooth torque transmission is ensured and the useful life is extended. At the same time, the backlash in the coupling part is prevented, a constant velocity is maintained, and vibrations and abnormal sounds are damped. The frictional resistance in the coupling part can be further reduced by installing the sliding member 84.

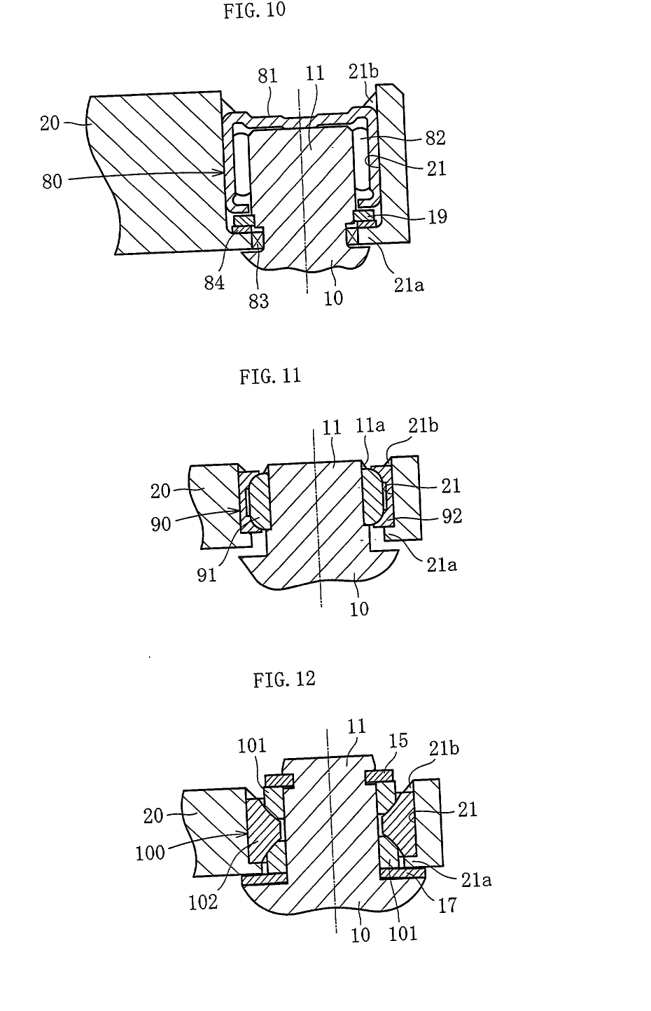

In a tenth embodiment shown in FIG. 11, a spherical bearing 90 is inserted between the leg shaft 11 and the coupling bore 21. The spherical bearing 90 has an inner ring 91, which is fitted on the outer peripheral surface of the leg shaft 11 and has a convex outer peripheral surface, and an outer ring 92 that is fitted in the coupling bore 21 of the end link member 20 and has a concave outer peripheral surface that fits on the outer peripheral surface of the inner ring 91. Slipping off of the inner ring 91 is prevented by a fastener 11a formed in the leg shaft 11. Slipping off of the outer ring 92 is prevented by the collar 21a formed in the coupling bore 21 of the end link member 20 and the fastener 21b.

Since the spherical bearing 90 is installed in the tenth embodiment of the invention, a smooth torque transmission is ensured in the coupling part and the useful life is extended. In addition, the coupling structure can be made compact because the spherical bearing 90 has a simple structure consisting of a small number of constituting components.

In an eleventh embodiment shown in FIG. 12, an inner-ring-split type spherical bearing 100 is installed between the leg shaft 11 and the coupling bore 21. The inner-ring-split type spherical bearing 100 has two inner rings 101, which are fitted on the outer peripheral surface of the leg shaft 11 and has a convex outer peripheral surface, and an outer ring 102 that is fitted in the coupling bore 21 of the end link member 20 and has two concave outer peripheral surfaces that are fitted on the outer peripheral surface of the inner ring 101.

Slipping off of the inner ring 101 is prevented by the snap ring 15 fitted on the outer peripheral surface of the leg shaft 11. The collar 21a formed in the coupling bore 21 of the end link member 20 and the fastener 21b prevent the outer ring 102 from slipping off. A plate spring 17 is installed between the base portion of the leg shaft 11 and the inner ring 101 positioned lower in the figure of the spherical bearing 100. A preload is applied to the spherical bearing 100 by the inner ring 101 that is pushed by the resilient force of the plate spring 17 so as to eliminate radial and thrust gaps.

In the eleventh embodiment of the invention, the inner-ring-split type spherical bearing 100 is installed and the preload applied to the inner-ring-split type spherical bearing 100 by the plate spring 17 eliminates radial and thrust gaps. Then a smooth torque transmission is ensured and the useful life is extended. At the same time, the backlash in the coupling part is prevented, a constant velocity is maintained, and vibrations and abnormal sounds are damped.

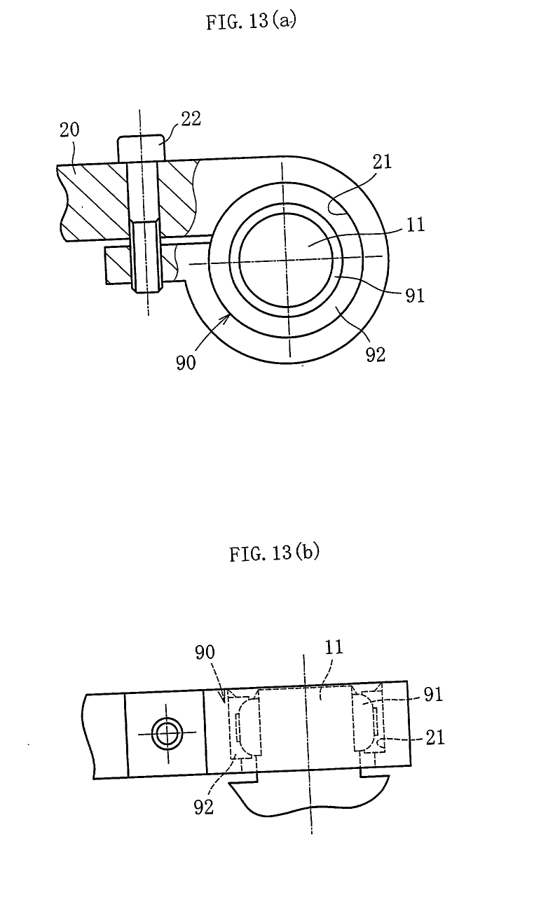

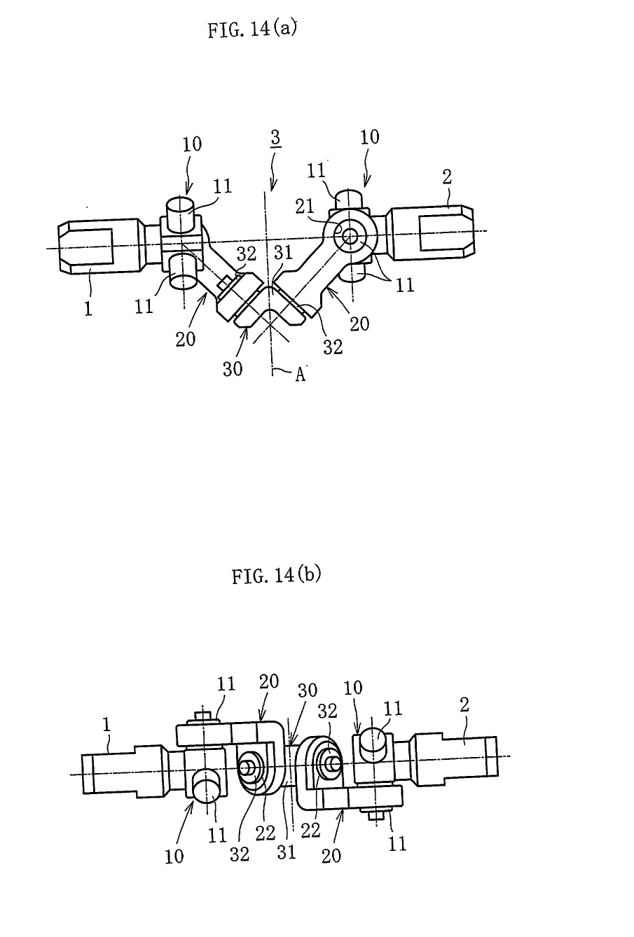

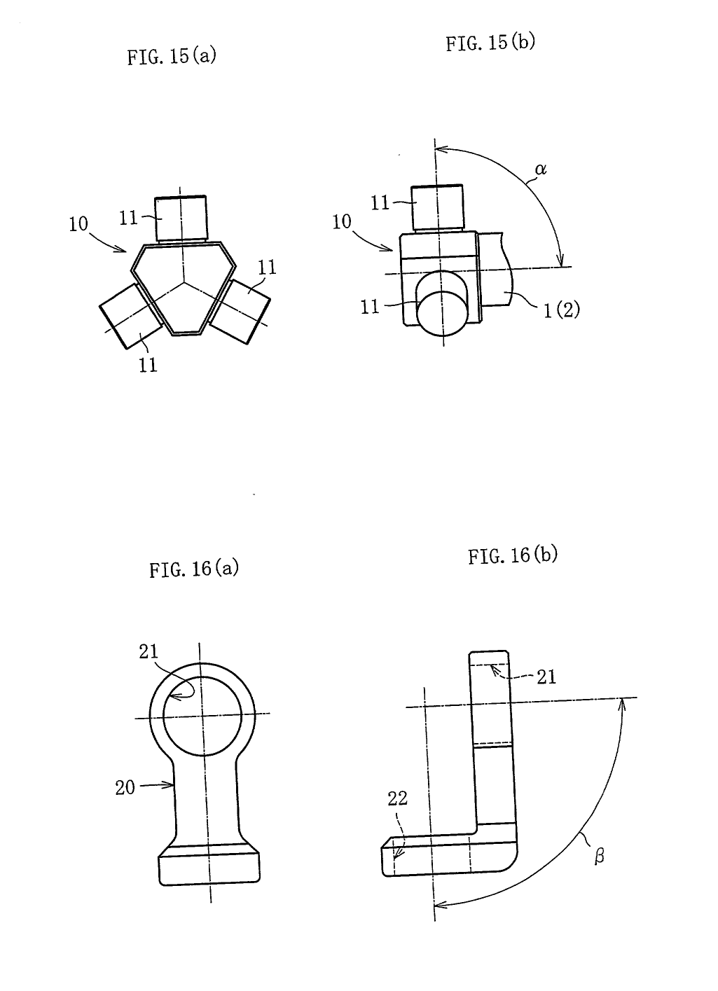

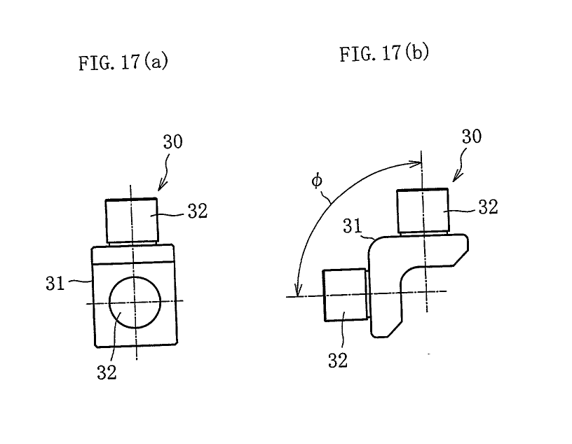

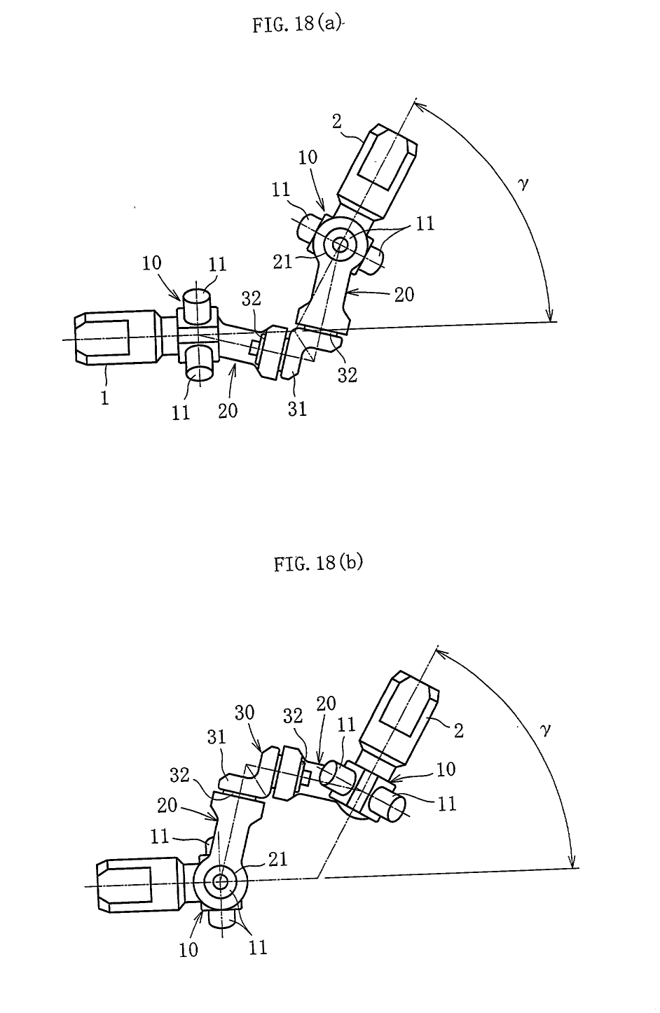

In a twelfth embodiment shown in FIGS. 13(a) and 13(b), the coupling bore 21 of the end link member 20 is expanded or shrunk by a clamping structure using a fastener bolt 22 in the tenth embodiment. The bearing gap in the spherical bearing 90 is controlled by expanding or shrinking the coupling bore 21 with the fastener bolt 22.

In the twelfth embodiment of the invention, the bearing gap in the spherical bearing 90 is adjusted by expanding or shrinking the coupling bore 21 of the end link member 20 with the fastener bolt 22. Then the backlash in the coupling part is prevented, a constant velocity is maintained, and vibrations and abnormal sounds are damped.

In the embodiments that have been described so far, the bearing installed between the end link member 20 and the link hub 10 lowers the rotational resistance in the coupling part. However, it is possible to employ materials having small friction coefficients and treat the surface for lowering frictional resistant, in order to reduce rotational resistance. As such material having small friction coefficients, copper alloys, graphite and fluororesin, for example, may be used in the coupling part between the end link member 20 and the link hub 10. In order to lower the friction coefficient by surface treatment, molybdenum dioxide, polytetrafluoroethylene (PTFE) and soft metals such as gold and silver may be coated on the surface of the coupling part.

Although the above embodiments have referred to the structure of the coupling part between the end link member 20 and the leg shaft 11 of the link hub 10, the embodiments can be applied to the coupling part between the end link member 20 and the leg shaft 32 of the central link member 30.

What is claimed is:

1. A constant velocity universal joint having at least two sets of link mechanisms, the link mechanism having: link hubs installed in an input shaft and an output shaft, respectively; end link members rotatably each coupled with the link hubs installed in the respective input and the output shafts; and a central link member to which the end link members on the respective input and output shaft sides are rotatably coupled, geometries of the mechanism on the input shaft side and the output shaft side being identical to each other across a transverse plane in a center of the link mechanism, wherein the constant velocity universal joint further has rotational resistance reducing means installed in at least either coupling part between the link hub and the end link member or coupling part between the central link member and the end link member.

2. The constant velocity universal joint according to claim 1, wherein said rotational resistance reducing means is a bearing installed in said coupling part.

3. The constant velocity universal joint according to claim 2, wherein said bearing is a roller bearing.

4. The constant velocity universal joint according to claim 2, wherein a journal bearing and a thrust bearing are installed in said coupling part, said journal bearing being a roller bearing and said thrust bearing being a sliding bearing.

5. The constant velocity universal joint according to any of claims 2-4, wherein preload providing means for applying a preload to said bearing is installed.
